(19) United States
(12) Patent Application Publication
(10) Pub. No.: US 2005/0127189 A1
(43) Pub. Date: Jun. 16, 2005

(54) Fixture for a flash memory card

(76) Inventors: Huang-Wei Hung, Hsichih City (TW); Tien-Fu Pan, Tucheng City (TW)

Correspondence Address: DELLETT AND WALTERS, P. O. BOX 2786, PORTLAND, OR, 97208-2786, US

(21) Appl. No.: 10/732,424

(22) Filed: Dec. 10, 2003

(51) Int. Cl. G06K 19/06

(52) U.S. Cl. 235/492

(57) ABSTRACT

A flash memory card includes a top cover having multiple positioning ribs and multiple guiding blocks both formed on opposite side faces of the head portion, a bottom cover engaged with the top cover and having multiple arcuate plates formed on opposite side faces of the bottom cover to correspond to the L-shaped hooks, a mediate frame sandwiched between the top cover and the bottom cover and having multiple positioning cutouts and multiple L-shaped indents to correspond to the positioning ribs and the guiding blocks respectively. The rear portion of the mediate frame has multiple through holes to receive the L-shaped hooks so that the L-shaped hooks are able to engage with the corresponding arcuate plates after the top cover is moved in a first direction relative to the mediate frame to complete the assembly of the flash memory card.

### BACKGROUND OF THE INVENTION

1. Field of the Invention

The present invention relates to a fixture, and more particularly to a fixture for a flash memory card to allow the top cover to be removable relative to the bottom cover such that the circuit board supported by the mediate frame and sandwiched between the top cover and the bottom cover is able to be removed for maintenance.

2. Description of Related Art

With reference to FIG. 5, a conventional flash memory card has a top cover (50) and a bottom cover (60) connected to the top cover (50).

The top cover (50) has multiple dovetailed barbs (51) formed along a peripheral contour of the top cover (50). A circuit board (70) is supported by the bottom cover (60) and is sandwiched between the top cover (50) and the bottom cover (60). The bottom cover (60) has multiple dovetailed holes (61) defined along a peripheral contour of the bottom cover (60) to correspond to the multiple dovetailed barbs (51). When the top cover (50) is to be combined with the bottom cover (60) to secure the circuit board (70) inside the flash memory card, the dovetailed barbs (51) are inserted into the corresponding dovetailed holes (6 1) of the bottom cover (60). Due to the elasticity of the dovetailed barbs (51), after the dovetailed barbs (51) are inserted into the dovetailed holes (61), the top cover (50) is securely and irreversibly connected to the bottom cover (60). That is, once the connection between the top cover (50) and the bottom cover (60) is finished, there is not a way to proceed maintenance to the circuit board (70) should there be any malfunction in the circuit board (70). Additional expense is thus incurred in the purchase of a new flash memory card, which is a waste of money.

To overcome the shortcomings, the present invention tends to provide an improved fixture for the flash memory card to mitigate the aforementioned problems.

### SUMMARY OF THE INVENTION

The primary objective of the present invention is to provide an improved fixture for the flash memory card to allow the user to proceed maintenance to the circuit board even after the assembly of the flash memory card is finished.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the flash memory card of the present invention;

FIG. 2 is an enlarged perspective view of a portion of the flash memory card of the present invention;

FIG. 3 is a schematic view in cross section showing the interrelationship between the top cover, the mediate frame and the bottom cover before assembly;

FIG. 3A is a cross sectional top view of the structural relationship in FIG. 3;

FIG. 4 is a schematic view in cross section showing the interrelationship between the top cover, the mediate frame and the bottom cover after assembly;

FIG. 4A is a cross sectional top view of the structural relationship in FIG. 4; and

FIG. 5 is an exploded perspective view of a conventional flash memory card.

### DETAILED DESCRIPTION OF THE PREFERRED EMBODIMENT

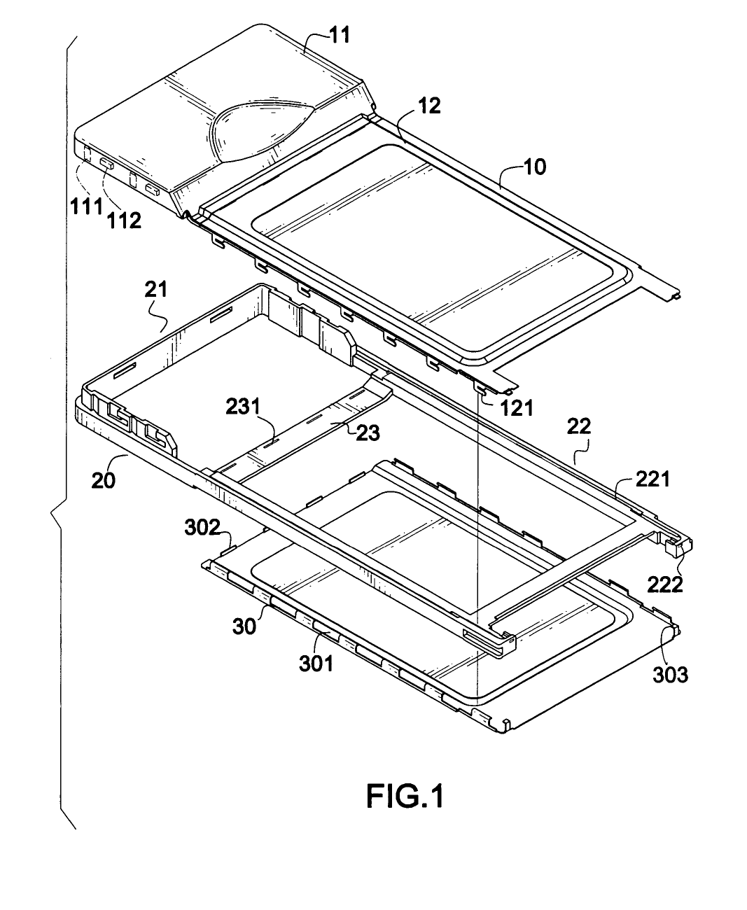

With reference to FIG. 1, the flash memory card in accordance with the present invention includes a top cover (10), a mediate frame (20) and a bottom cover (30).

The top cover (10) has a head portion (11) and a body portion (12) integrally formed with the head portion (11).

The mediate frame (20) has a front portion (21) to correspond to the head portion (11) of the top cover (10) and a rear portion (22) integrally formed with the front portion (21) to correspond to the body portion (12) of the top cover (10).

The bottom cover (30) has a dimension substantially the same as the dimension of the rear portion (22) of the mediate frame (20).

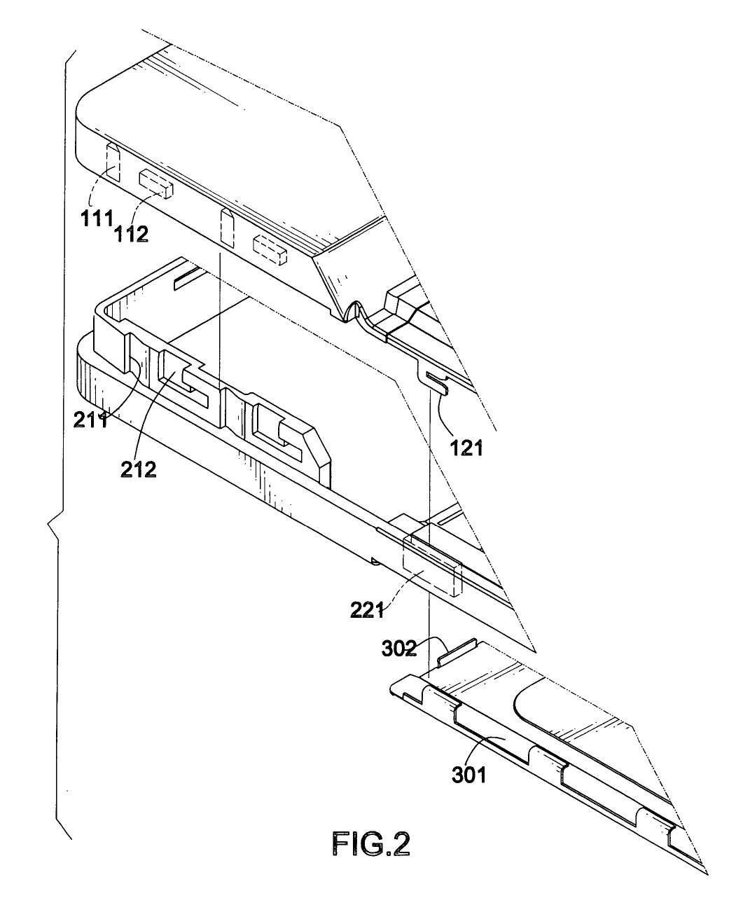

With reference to FIG. 2 and still taking FIG. 1 for reference, it is noted that the head portion (11) of the top cover (10) has multiple positioning ribs (111) formed on opposite inner side faces of the head portion ( 11) and multiple guiding blocks (112) also formed on the opposite inner side faces of the head portion (1 1). The positioning ribs (111) and the guiding blocks (112) are alternately formed with respect to one another. The body portion (12) of the top cover (10) has multiple L-shaped hooks (121) formed along two opposite peripheral edges of the body portion (12).

The front portion (21) of the mediate frame (20) has multiple positioning cutouts (211) corresponding to the positioning ribs (111) and multiple L-shaped indents (212) corresponding to the multiple guiding blocks (112). The multiple positioning cutouts (211) and the multiple L-shaped indents (212) are alternately formed with respect to one another and on opposite outer side faces of the front portion (21). The rear portion (22) of the mediate frame (22) has multiple holes (221) formed on opposite peripheral edges of the rear portion (22) to correspond to and allow the extension of the multiple L-shaped hooks (121) of the body portion (12) of the top cover (10). A widthwise bridge (23) is formed to connect the two opposite side faces of the mediate frame (20) and has multiple apertures (231) defined therethrough.

The bottom cover (30) has multiple arcuate plates (301) formed on two opposite side faces of the bottom cover (30) to correspond to the L-shaped hooks (121) of the top cover (10) and multiple extensions (302) formed on a side face sandwiched between the two opposite side faces to correspond to the apertures (231). Two auxiliary hooks (303) are formed on a side face of the bottom cover (30) and opposite to the extensions (302) to correspond to two slits (222) defined in a side face of the rear portion (22).

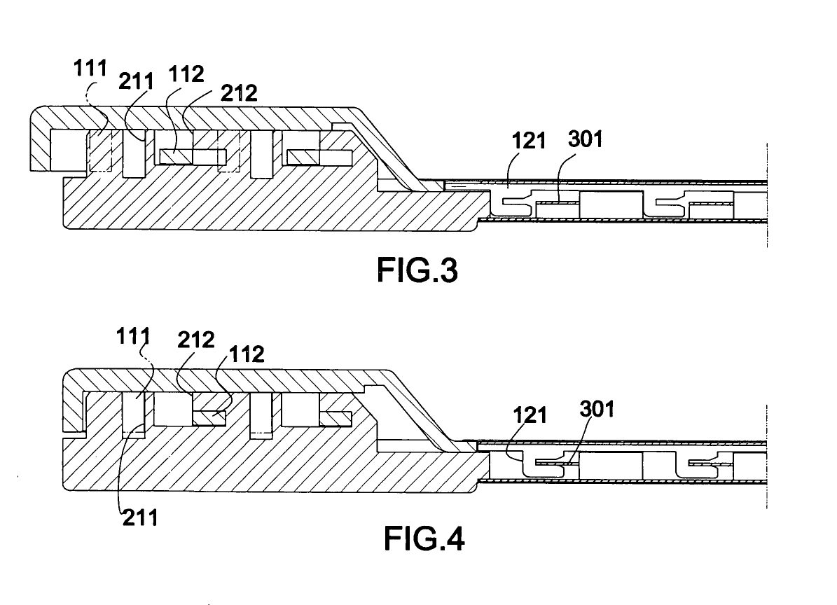

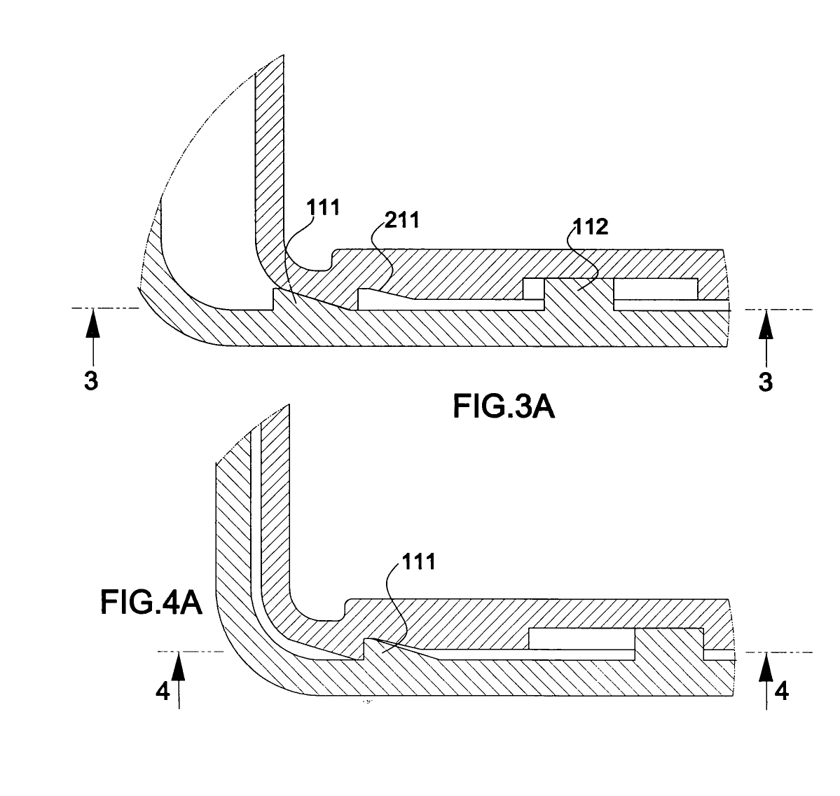

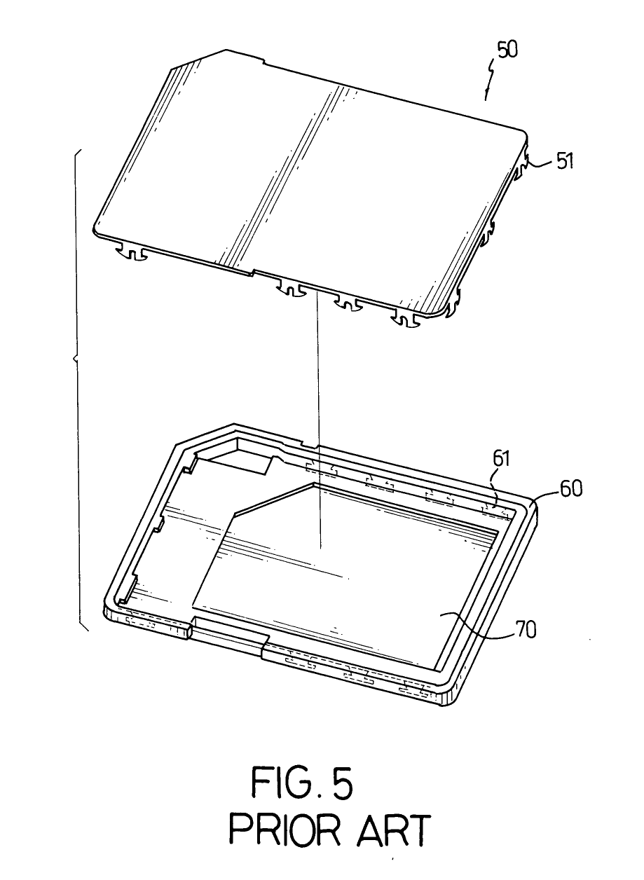

When the flash memory card of the present invention is to be assembled, with reference to FIGS. 3, 3A, 4 and 4A, the L-shaped hooks (121) are extended through the holes (221) of the mediate frame (20) and each of the L-shaped hooks (121) is adjacent to a corresponding one of the arcuate plates (301). In the meantime, the positioning ribs (111) are not yet received in the positioning cutouts (211) but the guiding blocks (112) are received in the L-shaped indents (212).

Sliding the top cover (10) relative to the mediate frame (20) in a first direction is able to allow the L-shaped hooks (121) to slide under the arcuate plates (301) to secure the engagement between the L-shaped hooks (121) and the arcuate plates (301). Meanwhile, the positioning ribs (111) as well as the guiding blocks (112) are respectively received in the positioning cutouts (211) and the L-shaped indents (212) to secure the engagement between the top cover (10) and the mediate frame (20). Furthermore, the extensions (302) are extended into the corresponding apertures (231) of the bridge (23) of the mediate frame (20) and the auxiliary hooks (303) are extended into the slits (222) so that the engagement between the bottom cover (30) and the mediate frame (20) is enhanced. Thus the assembly of the flash memory card of the present invention is finished.

When the disassembly of the flash memory card is required, the user is able to separate the top cover (10) from the bottom cover (30) by sliding the top cover (10) relative to the mediate frame (20) in a second direction opposite to the first direction to release the engagement between the L-shaped hooks (121) and the arcuate plates (301). Then, the separation between the top cover (10) and the bottom cover (30) is finished. However, during the siding of the top cover (10), the positioning ribs (111) and the guiding blocks (112) are also released from the limitation by the positioning cutouts (211) and the L-shaped indents (212) such that the top cover (10) and the mediate frame (20) as well as the bottom cover (30) are respectively separate from one another. Therefore, the user is able to proceed maintenance to the circuit board as required.

It is concluded that with the detachable connection between the top cover (10), the mediate frame (20) and the bottom cover (30), the user is able to easily proceed any work necessary and thus effort and money otherwise necessary through purchasing new flash memory cards are saved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A flash memory card comprising:
a top cover having a head portion and a body portion integrally formed with the head portion, the head portion provided with multiple positioning ribs and multiple guiding blocks both formed on opposite side faces of the head portion, wherein the positioning ribs and the guiding blocks are alternately formed relative to one another, the body portion provided with multiple L-shaped hooks formed on the opposite side faces of the body portion;
a bottom cover slidably engaged with the top cover and having multiple arcuate plates formed on opposite side faces of the bottom cover to correspond to the L-shaped hooks;
a mediate frame sandwiched between the top cover and the bottom cover, the mediate frame having a front portion corresponding to the head portion of the top cover and a rear portion corresponding to the body portion of the top cover, the front portion having multiple positioning cutouts and multiple L-shaped indents defined in opposite side faces of the front portion to correspond to the positioning ribs and the guiding blocks respectively such that the positioning ribs are slidably received in the corresponding positioning cutouts and the guiding blocks are slidably received in the corresponding L-shaped indents, the rear portion of the mediate frame having multiple through holes defined through opposite side faces of the rear portion of the mediate frame to correspond to the L-shaped hooks so that the L-shaped hooks are able to extend through the corresponding through holes to engage with the corresponding arcuate plates after the top cover is moved in a direction relative to the mediate frame and the bottom cover; and
a circuit board supported by the mediate frame and sandwiched between the top cover and the mediate frame.

2. The flash memory card as claimed in claim 1, wherein the mediate frame has a bridge extending between the two opposite side faces of the front portion and having multiple apertures defined in the bridge, the bottom cover has extensions formed on a side face sandwiched between the two opposite side faces to correspond to the apertures of the bridge such that insertion of the extensions into the corresponding apertures enhances engagement between the mediate frame and the bottom cover.

3. The flash memory card as claimed in claim 2, wherein the bottom cover has two auxiliary hooks formed on a side face sandwiched between the two opposite side faces and opposite to the extensions to correspond to two slits defined in a side face sandwiched between the two opposite side faces of the mediate frame and opposite to the apertures such that extension of the two auxiliary hooks into the corresponding slits is able to enhance the engagement between the mediate frame and the bottom cover.
